(19) United States
(12) Patent Application Publication
(10) Pub. No.: US 2025/0318477 A1
(43) Pub. Date: Oct. 16, 2025

(54) NON-COMBUSTIBLE MODULAR LIVING WALL SYSTEM

(71) Applicants: David Brenner, Albany, CA (US); Michael Carson Mangan, El Cerrito, CA (US)

(72) Inventors: David Brenner, Albany, CA (US); Michael Carson Mangan, El Cerrito, CA (US)

(21) Appl. No.: 19/088,957

(22) Filed: Mar. 24, 2025

Related U.S. Application Data
(63) Continuation-in-part of application No. 18/206,779, filed on Jun. 7, 2023, now abandoned.
Application No. 18/206,779 is a continuation-in-part of application No. 17/869,112, filed on Jul. 20, 2022, now abandoned.

(51) Int. Cl. A01G 9/02; A01G 24/18; A01G 27/00; E04B 1/66; E04B 1/94

(52) U.S. Cl. CPC A01G 9/025; A01G 24/18; A01G 27/00; E04B 1/665; E04B 1/94

(57) ABSTRACT

The present invention relates to a non-combustible, modular living wall system for facilitating plant growth on a structural wall of a building. The system includes attachment channels that secure one or more growing modules in place. Each growing module features a non-combustible growing cage and at least two growing substrates, with a capillary break formed by the cage's structural elements to help regulate water flow and maintain an optimal environment for plant growth. The substrates and cage are optionally enclosed by a non-combustible growing sleeve, and fire-resistant plant species are used to further enhance the system's safety profile.

### CROSS-REFERENCE TO RELATED APPLICATIONS

The present invention is a continuation in part application to U.S. Non-provisional application Ser. No. 18/206,779 filed Jun. 7, 2023 continuation in part application to U.S. Non-provisional application Ser. No. 17/869,112 filed Jul. 20, 2022, which is hereby incorporated in its entirety at least by reference.

### BACKGROUND OF THE INVENTION

### 1. Field of the Invention

The present invention relates generally to horticulture but more particularly to a living wall system.

### 2. Description of Related Art

Living walls, sometimes called green walls or vertical gardens, are vertically built structures configured to hold vegetation. While living walls have a great aesthetic appeal, they also provide good insulation to reduce the temperature of the building in which the living wall is installed. This makes living walls popular in urban environments. When installed indoors, living walls can improve air quality, climate, noise levels, and reduce CO₂.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide a living wall system configured to move water evenly throughout the system. It is another object of the invention to provide a living wall system maximizing water holding capacity and limiting runoff. It is another object of the invention to provide a scalable modular system that is easy to install, secure, and attach to wall structures. It is yet another object of the invention it utilize non-combustible materials to provide a high fire rating. It is yet another object of the invention it provide pre-grown plant modules or pre-seeded assemblies. It is yet another object of the invention to utilize fire resistant plants in the system to help contribute to the non-combustibility of the system.

In order to do so, embodiments of the present disclosure comprise a modular living wall system having a number of attachment channels configured to be fastened to a structural wall of a building; at least one growing module, each growing module including a growing cage configured to retain at least two growing substrates, wherein each growing substrate may be configured to facilitate the growth of plants; a capillary break between each growing substrate formed by the structure of the growing cage; and, the at least one growing module configured to connect to the number of attachment channels to form the modular living wall system.

In some embodiments, each growing substrate may be constructed from rockwool. In some embodiments, the growing cage may be constructed from stainless steel rods, and the capillary break may be formed via a double rod assembly. In some embodiments, each growing substrate includes openings configured to receive soil pockets or plant material.

In some embodiments, the modular living wall system may include a growing sleeve surrounding the at least one growing module. In some embodiments, each growing substrate includes a number of plant seeds distributed throughout the growing substrate. In some embodiments, the modular living wall system may include a facade panel having a number of openings at various geometries. In some embodiments, the number of openings may be configured to allow the growth of plants from the number of seeds to be visible or extend outside the facade panel.

In some embodiments, the at least one growing module may be wrapped in a growing fabric having perforations configured to receive a number of plant seeds. In some embodiments, the modular living wall system may include a facade panel having a number of openings at various geometries. In some embodiments, the number of openings may be configured to allow the growth of plants from the number of seeds to be visible or extend outside the facade panel. In some embodiments, the modular living wall system may include a waterproof membrane positioned directly between the at least one growing module and the structural wall.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a perspective view of a first living wall system according to an embodiment of the present invention.

FIG. 2 is an exploded view showing the assembly of the first living wall system according to an embodiment of the present invention.

FIG. 3 is an exploded view showing the composition of the first living wall system according to an embodiment of the present invention.

FIG. 4 show various channel types which may be utilized by the system according to an embodiment of the present invention.

FIG. 5A is a perspective view of the growing cage configured to hold the growing substrate according to an embodiment of the present invention.

FIG. 5B is a detailed view of FIG. 5A.

FIG. 5C is a perspective view of the growing cage including two growing substrate modules according to an embodiment of the present invention.

FIG. 6A is a right perspective view of the growing substrate according to an embodiment of the present invention.

FIG. 6B is a left perspective transparent view of the growing substrate according to an embodiment of the present invention.

FIG. 7 is a perspective view of a second living wall system according to an embodiment of the present invention.

FIG. 8 is an exploded view showing the composition of the second living wall system according to an embodiment of the present invention.

FIG. 9A is a perspective view of the facade according to an embodiment of the present invention.

FIG. 9B is a detailed view of FIG. 9A.

FIG. 9C is a detailed view of FIG. 9B showing plant growth.

FIG. 10A is a perspective view of a growing module consisting of a cage and growing substrate provided in the second living wall system according to an embodiment of the present invention.

FIG. 10B is a detailed view of FIG. 10A.

FIG. 11 is a perspective view of an alternative growing module according to an embodiment of the present invention.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide a living wall system.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about,” “generally,” or “approximately,” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

The term “non-combustible” as used herein refers to materials that meet or exceed recognized building-code standards and testing protocols for non-combustibility. By way of non-limiting example, such materials may satisfy ASTM E136 (Standard Test Method for Behavior of Materials in a Vertical Tube Furnace at 750° C.) or similar national or international fire safety standards. Non-combustible materials, when tested, do not support combustion and do not contribute to fire spread or smoke generation. The term “fire-resistant” as used herein pertains to materials or living organisms (e.g., plants) that exhibit low flammability, resist ignition, and/or impede the spread of fire. This typically includes, but is not limited to, materials with low or negligible oil/resin content, high moisture content, or inherently flame-retardant fiber properties, and plant species recognized in horticultural literature or fire-safety guidelines as having high water retention and minimal volatile compounds. Examples of such fire-resistant plant species have been detailed in the present disclosure below.

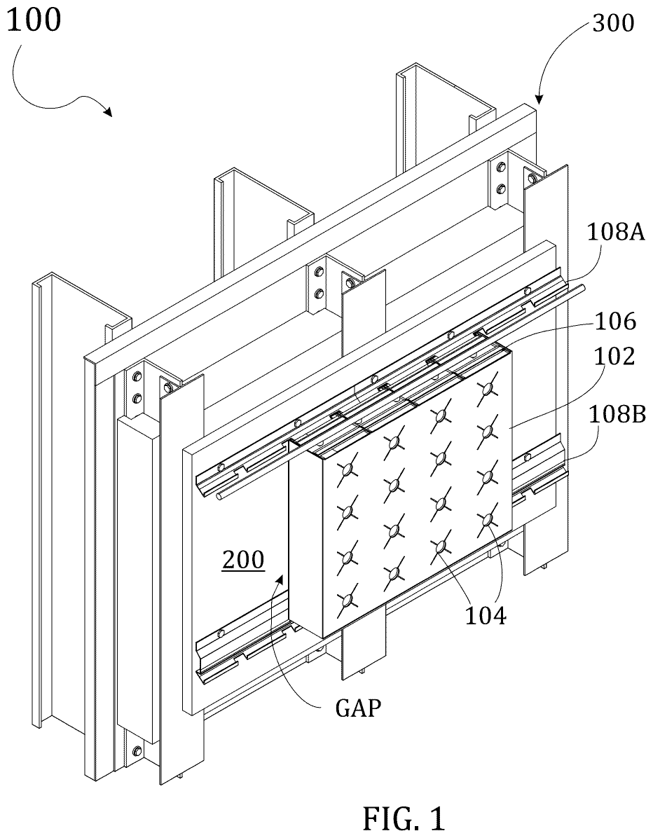

FIGS. 1-3 are various views of the living wall according to an embodiment of the present invention. Referring now to FIGS. 1-3, the living wall system 100 is illustrated. In one embodiment, the living wall is configured to be attached to a wall of a building 300 or other structure. A waterproofing membrane layer 200 is directly attached to the wall, preventing the wall from moisture during use. In one embodiment, waterproofing membrane layer 200 is a self-adhesive rubberized asphalt/polyethylene waterproofing membrane, such as Bituthene© 3000. In some embodiments, depending on the wall type, the waterproof membrane may not be necessary. Next, in some embodiments, a number of channels are used 108, wherein the channels are attached to the wall or structure 300 and are configured to attach one or more growing modules to the wall. This will be discussed in greater detail below. In some embodiments, a number of screws 120 are used for securing the channels 108 to the wall 300.

Still referring to FIGS. 1-3, a growing module consists of growing cage 106, growing substrate 110, and a growing sleeve 102. The growing cage is configured to hold one or more module growing substrate elements 110, which is then covered by a growing sleeve. In one embodiment, the growing sleeve is a non-combustible cover allowing for moss and byrophytes to establish on the face of the system while also securing the rockwool growing substrate and other components within the growing module. As moss and bryophytes inherently retain moisture and remain relatively cool, their presence on the face of the system does not significantly compromise the overall fire resistance provided by the non-combustible framework and substrates. In some embodiments, the non-combustible cover is constructed of carbonized fiber or similar material. Advantageously, the carbonized fiber surrounding the rockwool panels helps to retain moisture within the panel keeping the plants more hydrated. In some embodiments, a gap is provided between the waterproofing membrane layer 200 and the growing cage 106, configured to reduce airflow behind the growing modules. In one embodiment, the gap measures less than approximately one inch, thereby minimizing the chimney effect and reducing the potential for rapid vertical fire propagation.

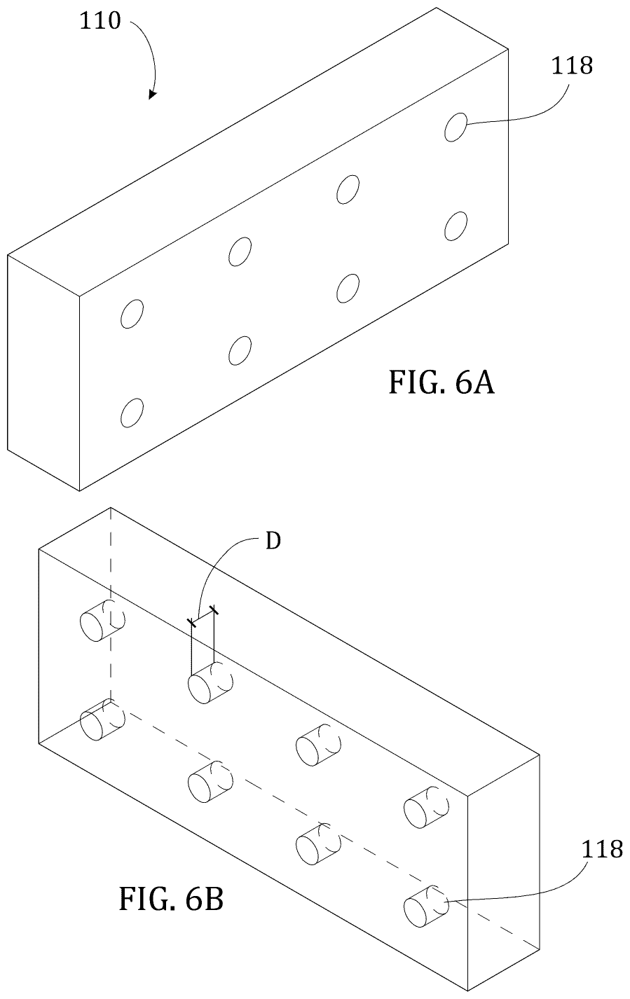

In some embodiments, optional and minimal pockets of soil or soilless medium (114) are configured to be inserted into the openings (118; FIGS. 6A-B) of the growing substrate (110). Because these pockets do not form any load-bearing or structural part of the wall and are limited in volume, and because the system's primary structural and substrate components (e.g., stainless steel rods, rockwool, and carbonized fiber) remain non-combustible, the overall fire resistance of the living wall is not substantially affected. Moreover, the pockets may utilize primarily inorganic or low-combustible growing mixes (e.g., pumice, perlite, or hydroponic media) rather than peat-heavy soils. In one embodiment, the growing substrate is constructed from rockwool. Plants 116 either provide as plugs, cuttings, semi-mature plants, grown plants, or seeds are positioned within the number of soil pockets 114. Finally, irrigation lines 112 having drip emitters are provided at the top of the system to provide irrigation to the living wall system such that appropriate levels of saturation can be maintained.

To maintain and enhance the overall fire-resistant characteristics and non-combustibility of the living wall system, it is important that the plants 116 be carefully selected from species known to exhibit fire-resistant properties. Such plants typically feature high moisture retention, succulence, low oil and resin content, and inherently low flammability, thereby significantly reducing the likelihood of ignition and slowing the spread of fire. Suitable fire-resistant species include, but are not limited to, Portulacaria afra, Senecio serpens, Oscularia deltoides, Kalanchoe pumila, Heuchera maxima, and Dudleya brittonii. These species, for example, have thick, moisture-rich leaves or stems that provide inherent resistance to ignition and combustion. Selecting these fire-resistant plant species not only contributes directly to improved fire safety performance of the system but also complements the fire-resistant properties of other system components, such as the non-combustible growing sleeve and rockwool substrate, collectively enhancing the system's resilience against potential fire hazards. Additional suitable species may similarly be selected based on recognized fire-resistant characteristics, environmental conditions, and compatibility with the overall structure and performance of the living wall system.

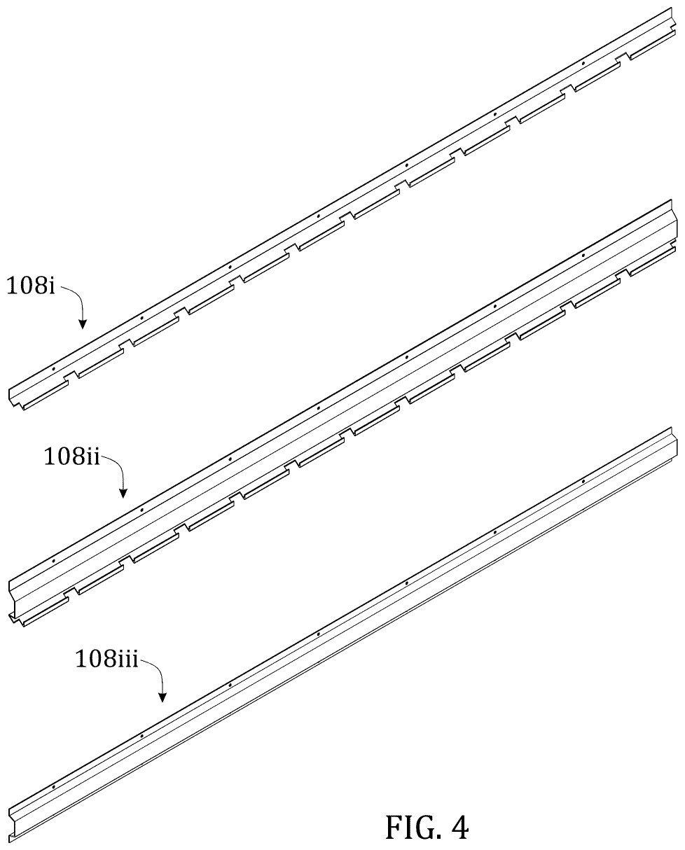

Referring now to FIG. 4, various channel types are shown. Advantageously, a fully assembled grow module may be attached or connected to one or more channels secured to the wall. In some embodiments, the channels are constructed from 16 gauge stainless steel, and usually 10 feet in length, but it is understood the size may vary. In some embodiments, an “L” clip channel 108i is positioned along the entire top portion or row of the living wall system. In some embodiments, a clip channel 108ii is positioned in every other proceeding row between the top and bottom rows of the living wall system. Finally, in some embodiments, a hat channel 108iii is positioned along the entire bottom row for every living wall application. Advantageously, the grow modules may be tilted, dropped, and set into the channels for easy installation.

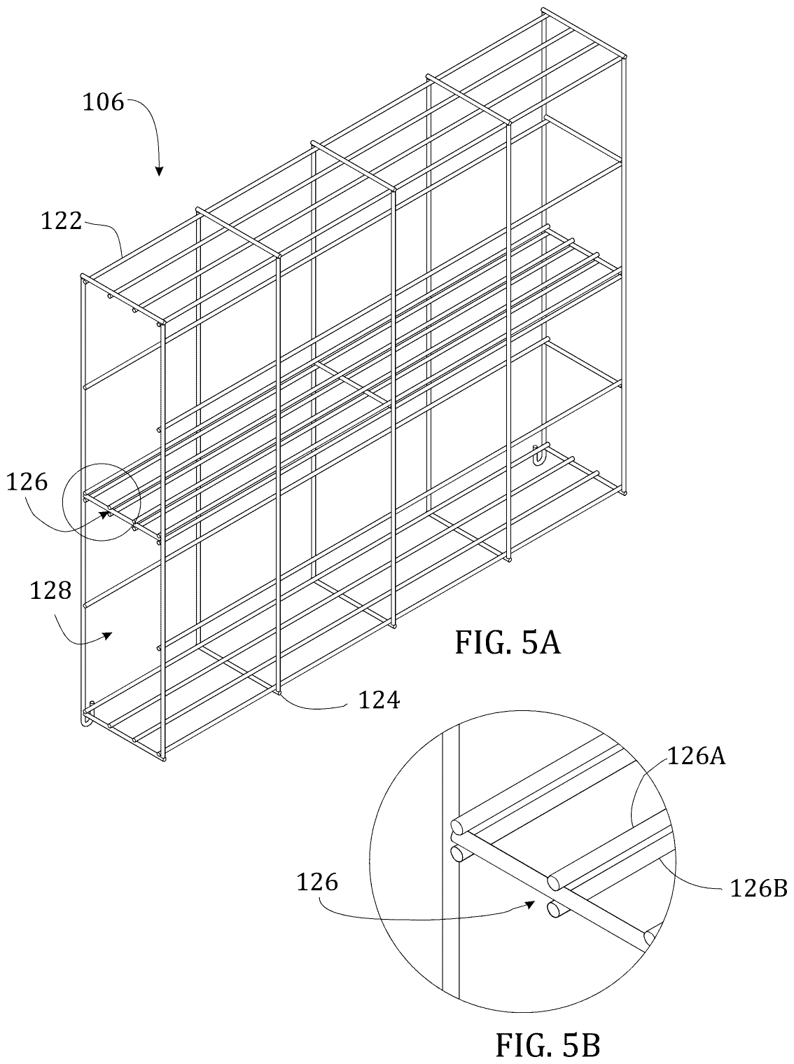

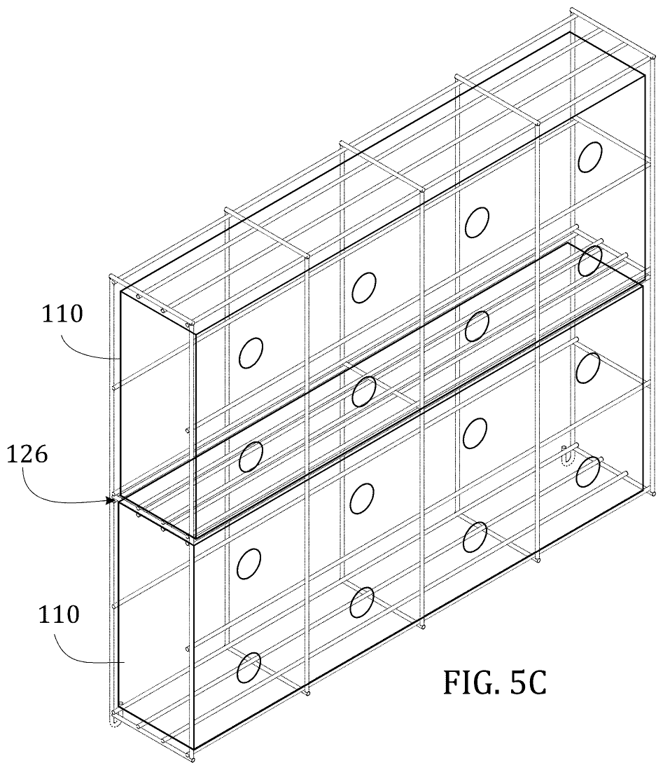

Referring now to FIGS. 5A-C, a perspective view of the growing cage 106 is illustrated. In some embodiments, the growing cage is constructed from ⅛″ steel stainless steel rods 122. Structural cross-rods 124 are provided to enclose and support the growing substrate modules 110 within the growing cage. It is a particular advantage of the present invention to provide a capillary gap 126 between growing substrate modules, wherein the capillary break is created by a specific arrangement of the rod construction. In one embodiment, the arrangement of rods may be defined as a double rod assembly 126A and 126B providing the capillary (best seen in FIG. 5B). In some embodiments, the rod spacing provides a ⅜″ capillary gap, but the distance of the gap may vary. Advantageously, the capillary break 126 provides and prevents the movement of water within the system at the capillary break to stop the capillary action as well known in the art. The capillary break helps to prevent excess water from running off the living wall system, and ensures even and adequate water distribution throughout the growing substrate to ensure proper hydration of the plants.

The capillary break, or capillary gap, is a critical feature of this living wall system, performing a crucial role in managing water distribution within the growing substrate modules. The capillary break, created by rod spacing that provides a gap of around ⅜″ (though this distance can vary), interrupts the natural capillary action that would otherwise draw water consistently upward through the growing substrates, opposing the force of gravity. This is particularly important in a vertical gardening system such as a living wall, where gravity naturally pulls water downward. Without the capillary break, capillary action could lead to an unequal distribution of moisture, with excess water accumulating in the upper sections and potentially depriving the lower portions of sufficient moisture. The capillary break halts this continuous capillary action, ensuring that water does not excessively accumulate in the upper portions of the wall and that the lower sections receive adequate moisture. Therefore, the capillary break plays a crucial role in maintaining an even water distribution throughout the living wall, promoting healthy and uniform plant growth across the entire surface. This also aids in preventing excess water from running off the system, reducing water waste and contributing to the overall efficiency and sustainability of the living wall.

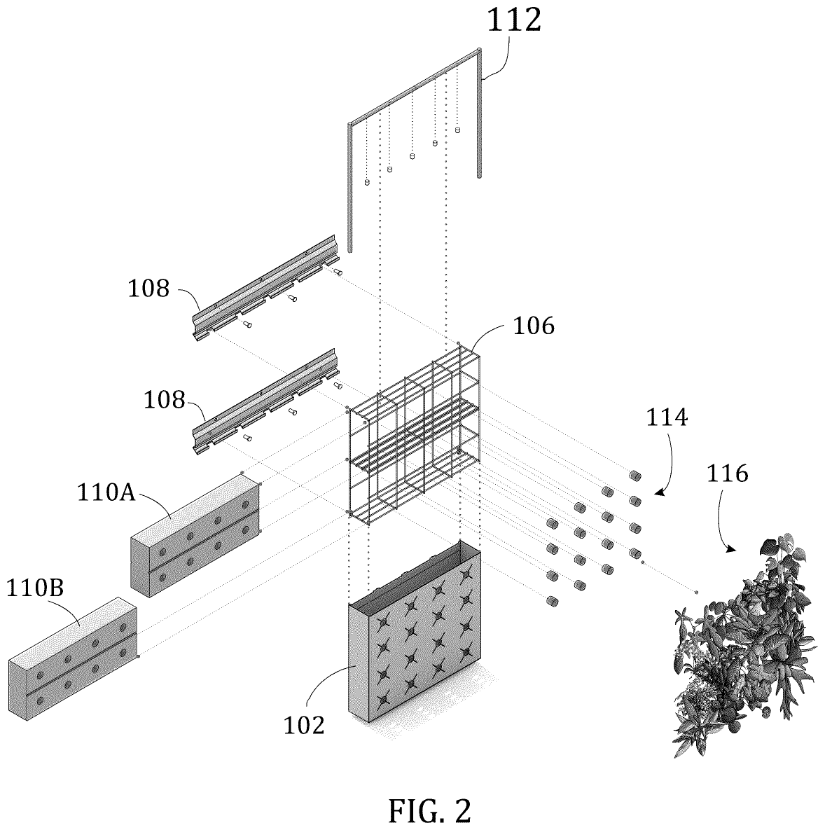

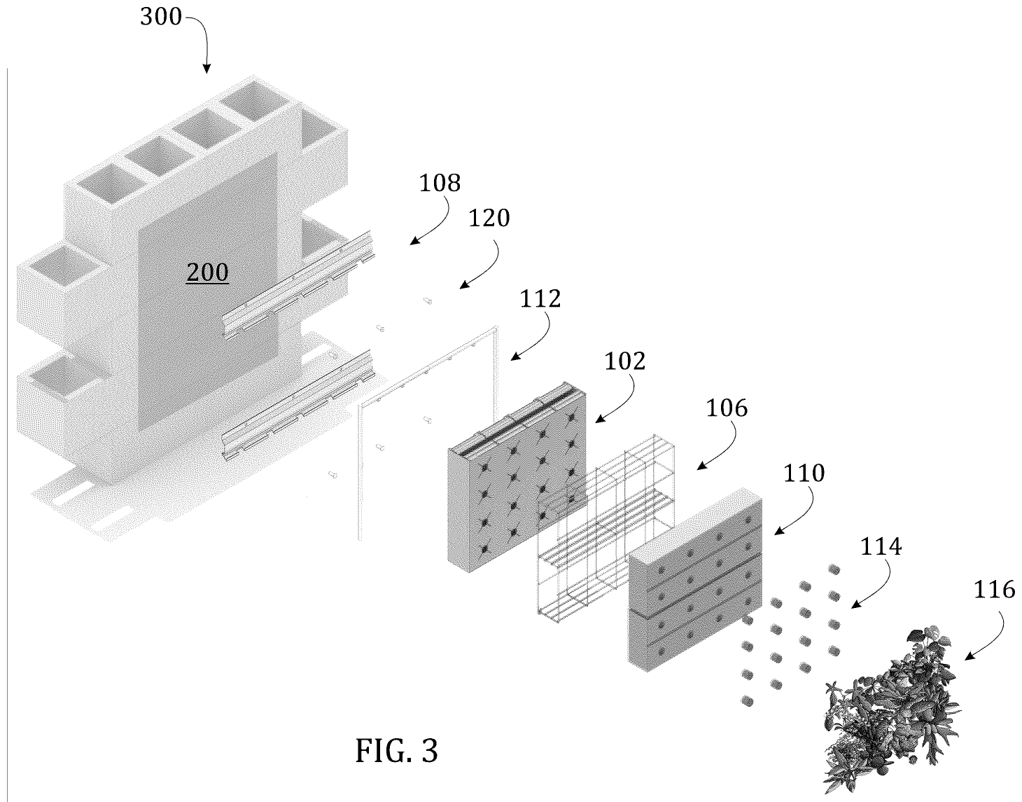

Referring now to FIGS. 6A-B, a detail of a single growing substrate module 110 is illustrated. In one embodiment, the growing substrate module is rectangular, and is constructed from rockwool. In one embodiment, the rockwool is a 100 density rockwool (100 kilograms per cubic meter). In each single growing substrate module 110 two rows of penetrations or openings 118 are provided, wherein the depth of the opening is approximately 1″. In some embodiments, the openings are approximately 1″ in diameter. In some embodiments, the living wall system, or more specifically the growing cage is configured to retain two growing substrate modules, such as seen in FIG. 5C. The openings are configured to receive soil pockets (114; FIGS. 2-3) or plant material as previously discussed. Although, openings are shown, in alternative embodiments, a pre-seeded growing substrate may be provided.

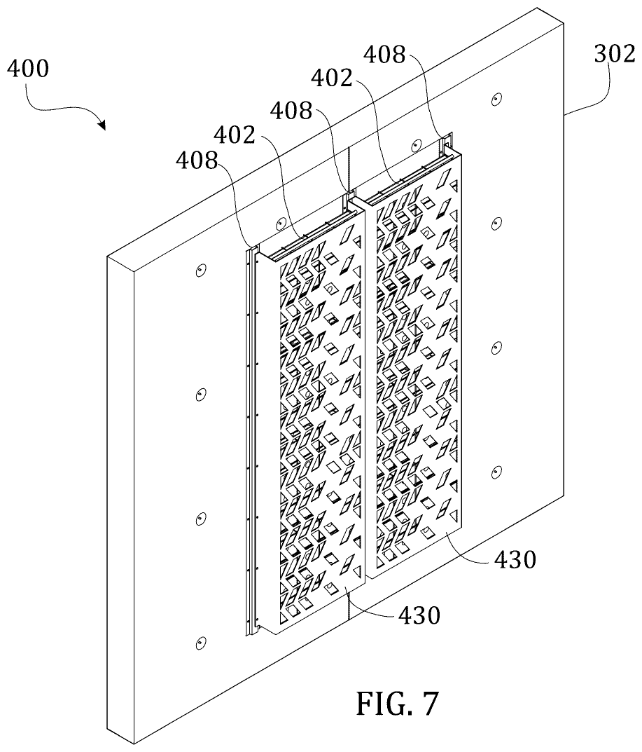

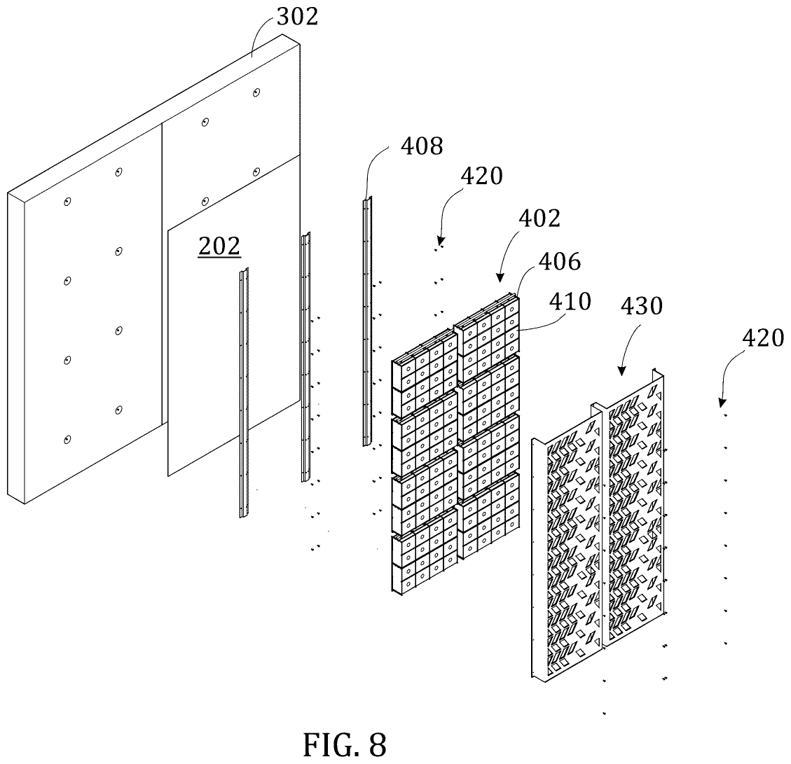

Referring now to FIGS. 7-8, a second or alternate living wall system 400 is illustrated. Similarly as the first living walls system, the second living wall system 400 is configured to attach to a structural wall 302 via number of channels 408. In one embodiment, hat channels are provided. Typically, a waterproof membrane 202 is used between the wall 302 and the living wall system 400, however, ultimately it depends on the wall type and construction. In some embodiments, applicable screws 420 are used to secure the number of channels 408 to the wall. Next, a number of growing modules 402 are provided, wherein the composition of each growing module 402 is as previously disclosed. More specifically, each growing module includes a growing cage 406 and two growing substrate modules 410. Advantageously, in this embodiment, a facade panel 430 is provided, wherein the facade panel provides the ability to customize the external look and design of the living wall. Again, applicable screws 420 are provided to secure the facade panel 430 to the assembly. Irrigation (not illustrated) is provided as previously discussed. Further, each growing module includes the advantageous capillary break system as previous discussed.

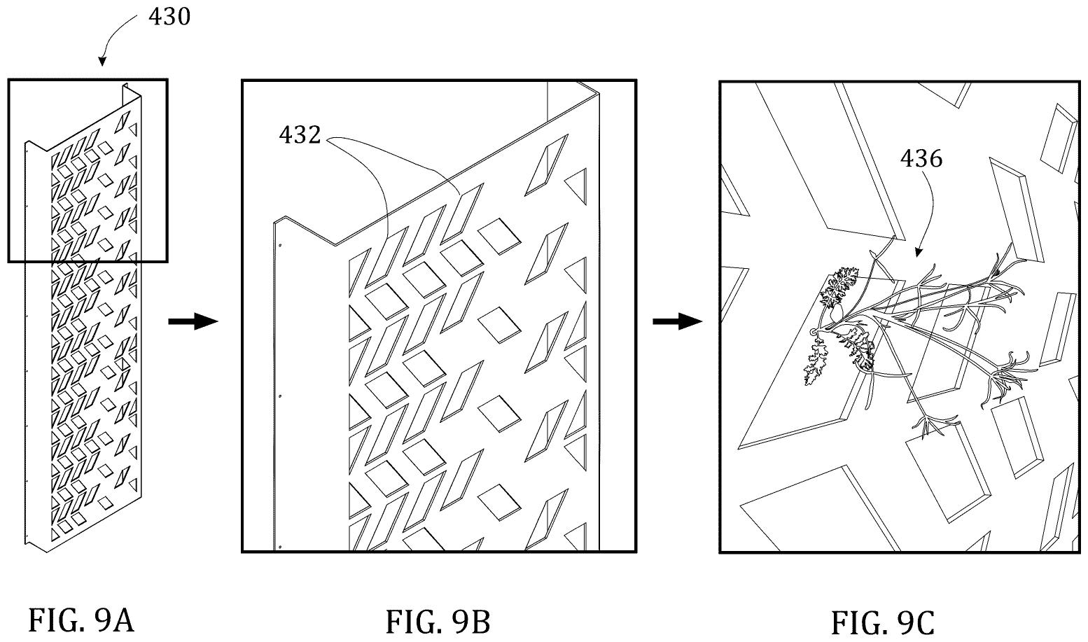

Referring now to FIGS. 9A-C, the details of the facade panel 430 is illustrated. In some embodiments, the facade panel has a plurality of openings 432 of various geometry. The geometry of the facade panel may vary depending on the selected plant varieties and the desired output or look the owner would like to achieve. The second living wall 400 is configured to be used with seeds, wherein the seeds sprout and are configured to conform to the customized aesthetics and geometry provided on the panel. The seeds are provided on the growing module which will be discussed in greater details below. In some embodiments, the facade panel 430 is constructed from stainless steel, and is configured to overlap and cover the growing modules of the living wall system. The number of openings, angles, locations, etc. of the facade panel may vary depending on the desired vegetation type, density, and appearance desired when the plant matter 436 is matured.

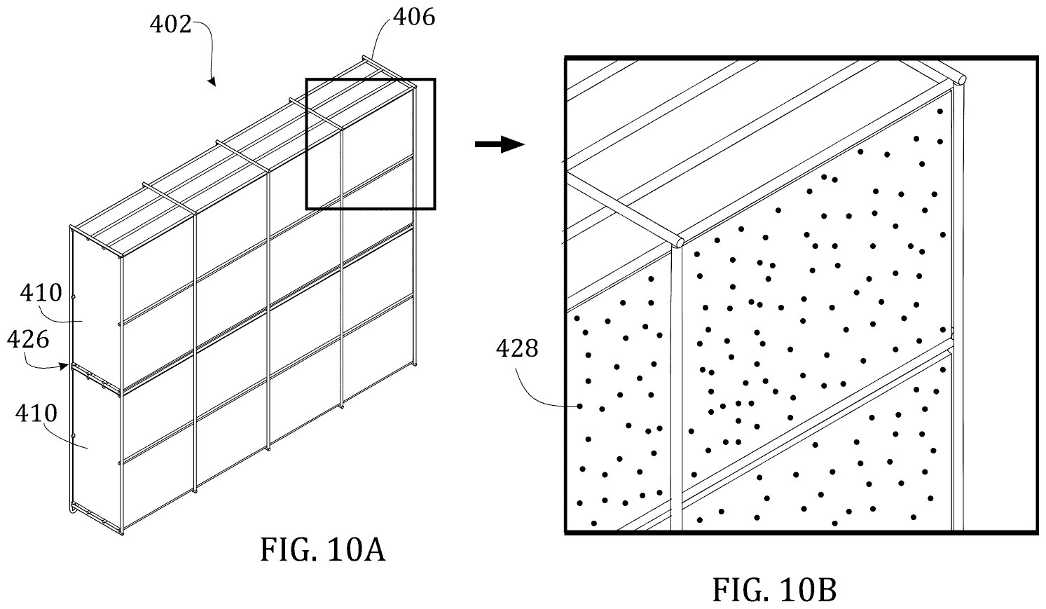

Referring now to FIGS. 10A-B, a growing module 402 is illustrated. In one embodiment, the growing module 402 includes a growing cage 406 and two growing substrates 410 separated by a capillary break 426 by previously disclosed means, such as the gap or spacing between rod assemblies. In one embodiment, the growing substrate 410 is constructed from rockwool. In this embodiment, seeds 428 are evenly distributed throughout the entirety of each module/growing substrate. Ultimately, the seed type, distribution, etc. may vary depending on desired outputs in related to the custom facade panel used for the living wall system.

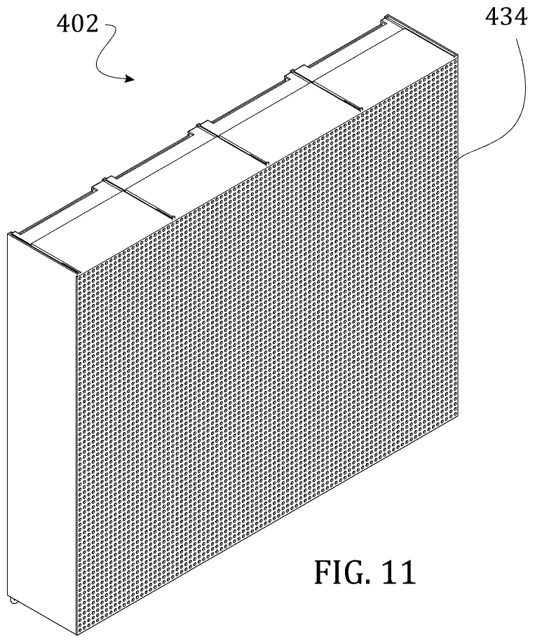

FIG. 11 shows an alternate embodiment, where the growing module 402 is wrapped in a growing fabric 434 for facilitating seedling growth. More specifically, the growing fabric 434 includes a number of needle-punch perforation that are configured to hold seeds. In some embodiments, a biodegradable glue is used to keep the seeds in place. In one embodiment, each perforation is approximately 1/16″. As previously, discussed, the facade panel is configured to cover the growing module during use, wherein the seed type, distribution, etc. may vary depending on desired outputs in related to the custom facade panel used for the living wall system.

It should be understood that the size of the living wall system may vary. Often, several growing modules are needed to meet the size requirement for a specific living wall installation.

In some embodiments, the system exclusively employs non-combustible cage materials such as stainless steel rods or carbon steel rods treated to meet non-combustible standards. The spacing and arrangement of these rods in the growing cage further contribute to fire safety by minimizing direct contact points for potential ignition and reducing the spread of flames. The growing substrates used in the system may also be constructed from or combined with certified non-combustible media. For example, rockwool blocks meeting ASTM E136 or analogous testing standards have demonstrated an ability to resist ignition and flame spread. In some embodiments, these substrates include additive binders or surface treatments enhancing moisture retention without compromising non-combustible characteristics. Surrounding each growing cage and substrate, a non-combustible growing sleeve, such as one composed of carbonized fiber as described above, acts as both a protective layer and a moisture-buffering layer for the plants. Carbonized fiber, in particular, has a reduced carbon-to-oxygen ratio that limits the tendency to ignite and slows the spread of flame or heat.

As previously mentioned, fire-resistant plant species selected for the modular living wall system are generally characterized by features like succulent leaves, dense water storage, and low volatile oils. By way of example, Portulacaria afra (commonly known as “elephant bush”) retains high moisture levels in its leaves, thereby delaying ignition and suppressing flame propagation. Senecio serpens (blue chalk sticks) and Oscularia deltoides (pink ice plant) similarly store water in their fleshy leaves. These and other enumerated species help maintain a living, green facade that both enhances aesthetics and adds a functional fire-retardant element.

To support healthy plant growth while maintaining the overall fire-resistant nature of the system, an integrated irrigation line may be provided. Typically, drip emitters or micro-spray nozzles are positioned at an upper edge of each row or module. The irrigation line may be routed vertically or horizontally behind or alongside the growing modules. Water is delivered in controlled amounts, ensuring the substrates remain sufficiently moist to sustain plant health without excessive runoff. Proper moisture levels in the substrates and plants further enhance their fire-resistant properties by increasing the water content present throughout the living wall system.

In some embodiments, one or more irrigation zones may be automatically controlled via solenoid valves connected to a moisture sensor or controller. This enables more efficient water use and helps maintain consistent substrate moisture, particularly in large-scale applications where multiple modules are stacked vertically.

Advantageously, the modular living wall system is designed to facilitate straightforward installation on existing or new structural walls. In one exemplary method of installing the system, the installer first attaches or bonds a waterproofing membrane directly to the structural wall. Next, one or more attachment channels (e.g., stainless steel hat channels) are fastened to the wall at predetermined intervals. This is followed by positioning each growing module—comprising the non-combustible cage, substrates, and surrounding sleeve—such that the module's support features engage with the installed channels. The modules are then lowered or tilted into place, ensuring a stable connection. The integrated irrigation lines may be installed concurrently or subsequently, depending on project requirements.

In regions where building codes dictate restricted air cavities behind cladding systems, an optional air gap of less than one inch may be maintained to minimize vertical airflow and reduce the chimney effect that can occur during a fire. Once all modules are seated, the irrigation system is connected to a water source or pump, and an initial watering cycle is performed to hydrate the substrates and support plant establishment. Where facade panels are present, those panels are attached to the channels using screws or brackets, ensuring alignment of openings with areas of emerging plant growth.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A non-combustible modular living wall system, comprising: a plurality of attachment channels configured to be fastened to a structural wall of a building; at least one growing module, each growing module comprising: a growing cage constructed from a non-combustible material that meets or exceeds recognized building-code standards for non-combustibility, the growing cage configured to retain at least two growing substrates; at least two growing substrates, each growing substrate being constructed from a non-combustible horticultural medium; a non-combustible growing sleeve surrounding the growing cage and the at least two growing substrates; and at least one plant selected from a species having fire-resistant properties; wherein the at least one growing module is connectable to the plurality of attachment channels to form the modular living wall system, and wherein the modular living wall system exhibits enhanced fire resistance due to the combination of non-combustible components and fire-resistant plant material.

2. The non-combustible modular living wall system of claim 1, further comprising a capillary break defined between adjacent growing substrates by an arrangement of structural elements forming the growing cage, the arrangement creating a gap sufficient to disrupt vertical capillary action.3. The non-combustible modular living wall system of claim 1, wherein each growing substrate comprises rockwool having a density sufficient to meet non-combustible testing standards.4. The non-combustible modular living wall system of claim 2, wherein the growing cage comprises stainless steel rods, and the capillary break comprises a gap formed by spacing between the stainless steel rods.5. The non-combustible modular living wall system of claim 1, wherein each growing substrate includes a plurality of openings configured to receive soil pockets, plug plants, or seeds.6. The non-combustible modular living wall system of claim 1, wherein the non-combustible growing sleeve comprises carbonized fiber having a moisture-buffering capacity that further enhances fire resistance.7. The non-combustible modular living wall system of claim 1, wherein the at least one plant is selected from the group consisting of Portulacaria afra, Senecio serpens, Oscularia deltoides, Kalanchoe pumila, Heuchera maxima, and Dudleya brittonii.8. The non-combustible modular living wall system of claim 1, further comprising an integrated irrigation system including at least one irrigation line disposed along an upper portion of each growing module, the irrigation line configured to deliver water to the at least two growing substrates in a controlled manner.9. The non-combustible modular living wall system of claim 1, further comprising: a waterproofing membrane positioned adjacent an external face of the structural wall; and an air gap of less than approximately one inch defined between the waterproofing membrane and the growing cage, the air gap being configured to limit vertical airflow and reduce a chimney effect in the event of fire.10. The non-combustible modular living wall system of claim 1, wherein each growing substrate comprises seeds distributed throughout the substrate, and a facade panel having a plurality of openings aligned to allow emerging plant material to pass therethrough.11. A non-combustible modular living wall system, comprising: a plurality of attachment channels configured to be fastened to a structural wall of a building; at least one growing module, each growing module comprising: a growing cage constructed from a non-combustible material that meets or exceeds recognized building-code standards for non-combustibility, the growing cage configured to retain at least two growing substrates, at least two growing substrates, each growing substrate being constructed from a non-combustible horticultural medium; a non-combustible growing sleeve surrounding the growing cage and the at least two growing substrates, wherein the non-combustible growing sleeve comprises carbonized fiber having a moisture-buffering capacity configured to enhance fire resistance; at least one plant selected from a species having fire-resistant properties; wherein the at least one growing module is connectable to the plurality of attachment channels to form the modular living wall system, and wherein the modular living wall system exhibits enhanced fire resistance due to the combination of non-combustible components and fire-resistant plant material; and
a waterproofing membrane positioned adjacent an external face of the structural wall; and an air gap of less than approximately one inch defined between the waterproofing membrane and the growing cage, the air gap being configured to limit vertical airflow and reduce a chimney effect in the event of fire.

12. A method of installing a non-combustible modular living wall system on a structural wall of a building, the method comprising: attaching a waterproofing membrane directly to the structural wall; fastening a plurality of non-combustible attachment channels to the structural wall, the attachment channels configured to receive at least one growing module; assembling each growing module by disposing at least two non-combustible growing substrates within a growing cage, the growing cage having a capillary break formed by a gap between structural elements of the cage; surrounding the growing cage and the at least two growing substrates with a non-combustible growing sleeve; positioning at least one fire-resistant plant species in or on the at least two growing substrates; connecting each growing module to at least one of the attachment channels, thereby forming the modular living wall system; and installing an irrigation line configured to deliver water to the at least two growing substrates,
wherein each module and its constituent materials exhibit enhanced fire resistance due to the non-combustible construction and the selection of a fire-resistant plant species.
